(19) United States
(12) Patent Application Publication
(10) Pub. No.: US 2004/0130166 A1
(43) Pub. Date: Jul. 8, 2004

(54) Profile for an automobile structural element and corresponding chassis

(76) Inventors: Olivier Trancart, La Queue Lez Yvelines (FR); Alain Peyronni, Neauphle le Chateau (FR)

Correspondence Address: David J. Simonelli, Clark Hill PLC, 500 Woodward Avenue, Suite 3500, Detroit, MI, 48226-3435, US

(21) Appl. No.: 10/611,830

(22) Filed: Jul. 1, 2003

(30) Foreign Application Priority Data
Jul. 3, 2002 (FR) 02-08332

(51) Int. Cl. B60R 19/02

(52) U.S. Cl. 293/102

(57) ABSTRACT

This profile (14) for a structural element of an automobile extends in a longitudinal direction (L) and includes an outer envelope (15A) defining a closed content in cross-section. It includes a transverse rigidification core (15B) inside the envelope (15A) linking opposite points of the envelope. The profile is made from a metal sheet blank with two longitudinal edges (44, 46). The blank includes an area (32) forming the rigidification core (15B) of the profile, and a longitudinal margin (40, 34, 36, 29A, 38, 30, 42, 29B) folded longitudinally, the two longitudinal edges (44, 46) of the blank being joined to the said metal sheet blank in its running part.

### BACKGROUND ART

1. Field of the Invention

The present invention concerns a profile for use as an automobile structural element, notably part of the front or rear bumper structure, the profile extending in a longitudinal direction and including an outer envelope defining a closed content in cross-section.

2. Description of the Related Art

It is notably applied to bumpers for automobiles. Bumper beams made of metal profiles are already known. Generally two profiles with open cross-sections are welded together along their edges, forming a profile with a closed cross-section. These profiles have a high manufacturing cost because of the different profiles which have to be welded and manipulated. The present invention is intended to alleviate the above-mentioned disadvantages, in proposing a metal profile with a low manufacturing cost while retaining a high level of rigidity for the given dimensions.

### SUMMARY OF THE INVENTION

For this purpose, the invention concerns a profile of the above-mentioned type, characterized in that it includes a transverse core for rigidity inside the envelope and connecting two opposite points of the envelope. The profile is produced from a blank metal sheet with two longitudinal edges, the blank sheet consisting of an area forming the rigidification core of the profile, and at least one longitudinal margin folded longitudinally. The two longitudinal edges of the metal sheet blank are joined to the metal sheet in its running part.

According to other manufacturing methods, the profile according to the invention includes one or more of the following characteristics:

the envelope has a cross-section in the form of a quadrilateral and includes two widths and two heights, the rigidification core extending between the widths, the cross-section being formed of:

six envelope section segments including two section segments forming the two widths and two section segments forming the two heights each time, as well as by

two first and second joining parts, and in that it includes one section segment which forms the rigidification core;

the blank sheet includes two longitudinal margins which run on either side of the said rigidification core and the said margins are folded in opposite directions towards the said rigidification core;

the cross-section is formed by the following succession of section segments:

first part of connection

first section segment of a first height

section segment of a first width

first section segment of a second height

section segment of a rigidification core

second section segment of the said first height

section segment of a second width

second section segment of the said second height

second part of the connection;

the blank sheet is folded by about 90° from one section segment to the next, in the said first direction between the said first section segment of the said first height and the section segment of the rigidification core and in the said second direction between the section segment of the rigidification core and the said second section segment of the said second height;

the cross-section is symmetrical to a central axis extending longitudinally;

the metal sheet blank has a single longitudinal margin folded in a single direction around the rigidification core;

the cross-section of the profile is formed by the following succession of section segments:

first part of connection

first section segment of a first height

section segment of a first width

first and second section segments of a second height

section segment of a second width

second section segment of the said first height

section segment of the rigidification core

second part of connection;

the metal sheet is folded by roughly 90° between one section segment and the next in the said first direction of folding, except for the link between the said first and second section segments of the said second height, these two section segments extending roughly parallel to each other;

the metal sheet blank is folded roughly 90° between the section segment of the rigidification core and the said second part of the connection, notably in a second direction of folding opposite to the first direction of folding;

the profile includes at least one rigidification strip extending along the length of the profile, notably forming a hollow open towards the outside of the profile;

the two section segments of width and/or the section segment of the rigidification core are domed; and

the thickness of the metal sheet blank is roughly identical throughout the cross-section.

The invention is also for use in an automobile chassis consisting of two members and a bumper, characterized in that the bumper includes a profile as described above.

### BRIEF DESCRIPTION OF THE DRAWINGS

The invention will be better understood on reading the following description, given uniquely as an example and drawn up with reference to the appended drawing, in which:

FIG. 1 is an exploded diagram of the front part of an automobile chassis, including a profile according to the invention;

FIG. 2A is a cross-section of the profile as in plan IIA of FIG. 1;

FIGS. 2B and 2D are two cross-sections of variants of the profile shown in FIG. 2A; and

FIGS. 2E and 2F are cross-sections of variants of a second method of producing the profile according to the invention.

### DETAILED DESCRIPTION OF THE PREFERRED EMBODIMENT

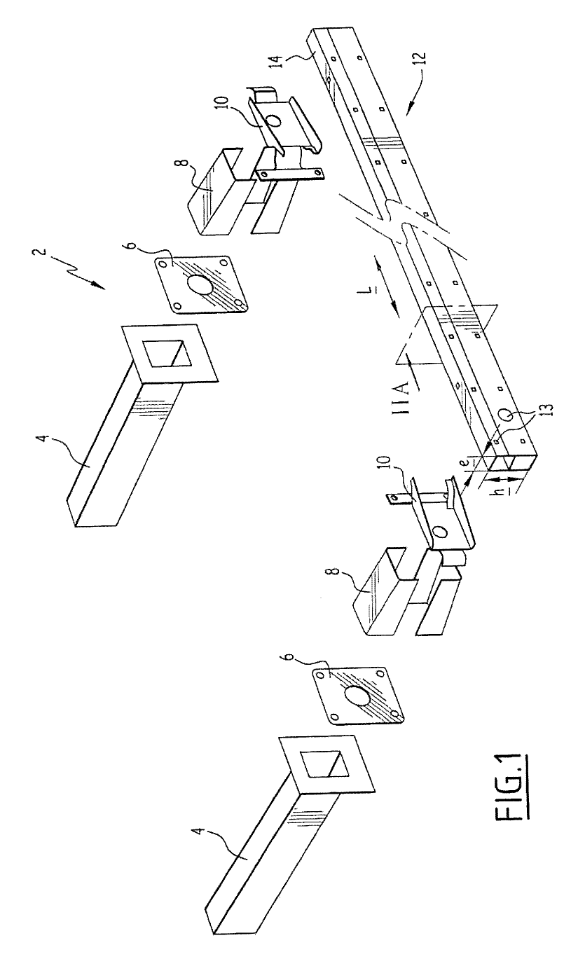

FIG. 1 shows an exploded perspective diagram of part of an automobile chassis designated by the general reference 2. Chassis 2 includes two members 4 which extend parallel to each other from the front of the vehicle towards the rear. Each member 4 is closed at its front extremity by a terminal plate 6. Each terminal plate 6 has a shock-absorber 8 fastened to it, extending towards the front. A beam support 10 is set at the front end of each shock-absorber 8. Between the two beam supports 10 and in front of these is a bumper beam 12.

In the following text, the expression “longitudinal” will indicate a direction L extending between the two members and defining the largest dimension of the bumper beam 12. The bumper beam 12 includes openings 13 for mounting components. The bumper beam 12 consists of a profile 14 made of sheet metal. The expressions “front”, “rear”, “upper” and “lower” will be used to describe the usual orientations of the vehicle.

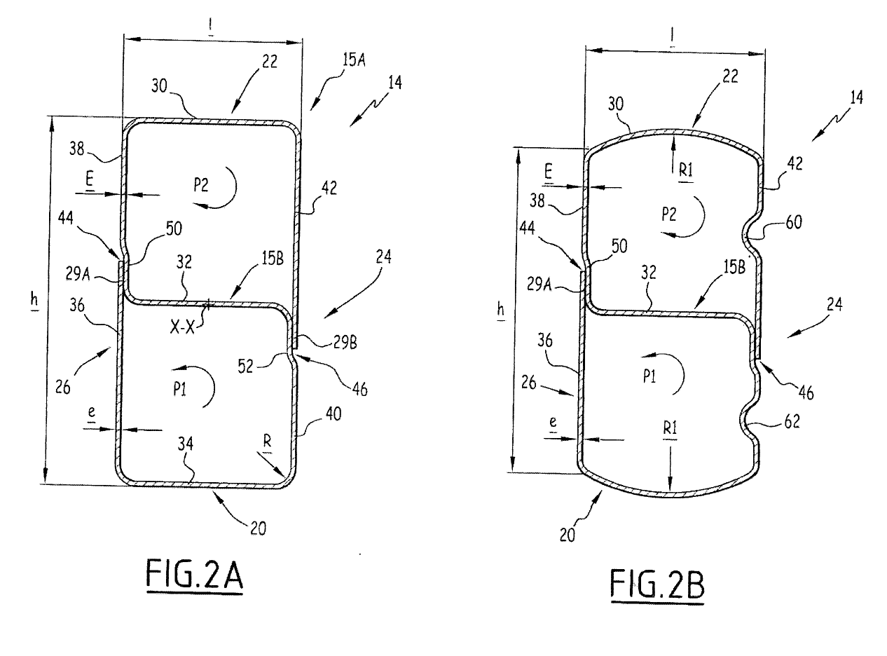

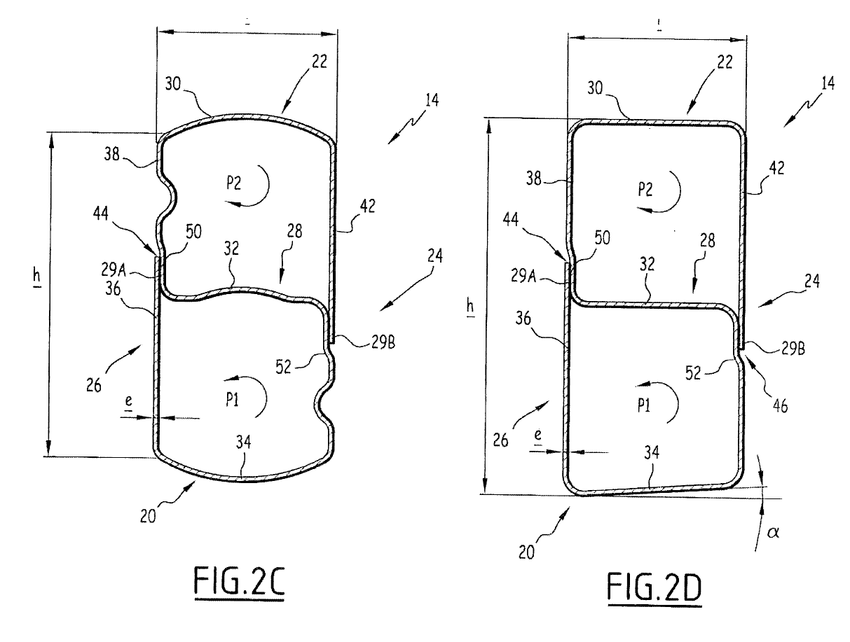

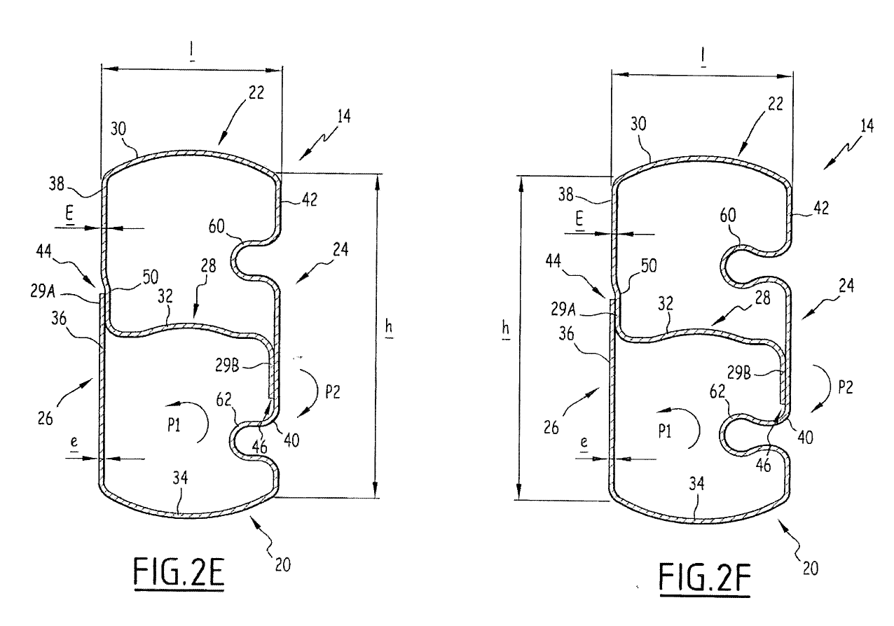

FIG. 2A shows a cross-section of the profile 14, as in plan IIA of FIG. 1. The plane of the section is perpendicular to direction L. The profile consists of an envelope 15A and a transverse rigidification core 15B.

The cross-section of the envelope 15A defines a closed contour with the outer general shape of a quadrilateral, in this case a rectangle. It has a width 1 and a height h. When mounted, the width 1 of the bumper 12 is measured in the general direction of the members and extends from the front of the vehicle to the rear 4. The height h extends from top to bottom when beam 12 is mounted.

The cross-section includes a lower width 20, an upper width 22, a front height 24 and a rear height 26. These dimensions 20, 22, 24 and 26 define envelope 15A of the profile 14. The rigidification core 15B extends between the front height 24 and rear height 26, roughly parallel to widths 20 and 22 and halfway between them. The cross-section of profile 14 is, therefore, composed of two first 29A and second 29B parts of the connection and of seven section segments.

A first section segment 30 forms the upper width 22, a second section segment 32 forms the rigidification core 15B and a third section segment 34 forms the lower width 20. The rear height 26 consists of a fourth lower section segment 36, and a fifth upper section segment 38. The front height 24 consists of a sixth lower section segment 40 and a seventh upper section segment 42.

The profile 14 consists of a single metal sheet blank folded, of thickness e, which is constant throughout the width of the sheet. The metal sheet blank has longitudinal edges 44, 46. The parts adjacent to the longitudinal edges 44, 46 of the metal sheet blank form parts of the connection 29A, 29B. The metal sheet blank includes an area 32 forming the rigidification core 15B as well as two longitudinal edges. A first margin, constitutes the first section segment 30, the fifth section segment 38, the seventh section segment 42 and the second part of the connection. The second margin constitutes the third section segment 34, the fourth section segment 36, the sixth section segment 40 and the first part of the connection 29A.

The margins are folded longitudinally so that each of the first 29A and second 29B parts of the connection partly overlap one of the section segments. The parts of connection 29A, 29B are applied to the surface of this respective section segment and are welded to it by spot-welding. In the present case, the first part of connection 29A is welded to the fifth segment of section 38, while the second part of connection 29B is welded to the sixth segment of section 40. Each section segment is connected to an adjacent section segment by part of the metal sheet folded by about 90°. The succession of section segments along the width of the metal sheet blank, between the longitudinal edges 44, 46, is as follows:

The first part of connection 29A, fourth segment of section 36, third segment of section 34; sixth segment of section 40; second segment of section 32; fifth segment of section 38, first segment of section 30; seventh segment of section 42; and second part of connection 29B.

The metal sheet is folded in one direction P1, anti-clockwise in FIG. 2A between the fourth 36 and the third 34, between the third 34 and the sixth 40, as well as between the sixth 40 and the second 32 section segments. Between the second 32 and the fifth 38, between the fifth 38 and the first 30, as well as between the first 30 and the seventh 42 section segments, the metal sheet is folded in a second direction P2, opposite to that of the first direction of folding P1. In this case, this direction P2 is clockwise in FIG. 2A.

The fifth 38 and the sixth 40 section segments each have a flange, 50, 52 of width E, identical to the thickness e of the metal sheet. These flanges, 50, 52 hold the connection parts 29A, 29B. Section segments 30, 32, 34, 36, 38, 40 and 42 are straight. The folded parts have a inner radius of curvature R, which is at least three times the thickness e of the metal sheet, for example R≦3.6 mm for a thickness e of the metal sheet of 1.2 mm.

The metal sheet blank consists of a steel sheet with a high elastic limit, preferably with a breaking strength in excess of 800 MPa and preferably below 1000 MPa. It is noted that the cross-section of profile 14 is symmetrical with respect to an axis X-X extending along the length L of the beam 12. In a variant, the connecting parts 29A, 29B are welded by MIG welding. The profile, according to the invention is made by first producing a metal sheet blank or strip with a width corresponding to the total width of the section segments 30 to 42 and the connection parts 29A, 29B. The metal strip is then folded and welded according to its length in a continuous weld, with several stages of folding and welding. Then, the strip goes through a shaping stage which forms the flanges 50, 52. The strip then undergoes a folding stage which forms the two 90° folds adjacent to the second segment of section 32, which forms the rigidification core 28, these two folds being folded in opposite directions to each other. The strip then goes through two successive stages of folding at 90° to form the folds connecting the sixth segment of section 40 and the third segment of section 34, as well as the third segment of section 34 and the fourth segment of section 36. The first part of connection 29A then fits against flange 50. The first part of connection 29A is welded to flange 50.

Next, the semi-finished profile obtained goes through two successive stages of folding at 90° to form the folds connecting the fifth segment of section 38 and the first segment of section 30, as well as the first segment of section 30 and the seventh segment of section 42. The second part of connection 29B then fits against flange 52. The second part of connection 29B is welded to the second flange 52.

To shape the bumper beam 12, the profile 14 thus obtained is cut to the length required for beam 12. Consequently the profile can be used for vehicles of different widths.

Finally, the openings 13 for mounting the components on the beam, are cut. Beam 12 is eventually curved according to its length. Note that the folding stages take place cold. Therefore, production of the profile uses very little energy. By folding, the metal sheet material retains roughly its initial thickness. The metal sheet used for the profile 14 can also be sheeting with a high elastic limit, which does not require any further treatment or hardening after the shaping process of profile 14.

FIG. 2B shows a cross-section of a variant of a profile according to the invention. The differences with respect to the profile described above will be indicated. Analogous parts will have the same references.

Widths greater than 23 and less than 20 have a convex, domed cross-section. In this case the cross-section is in the form of the arc of a circle of radius R1. The envelope 15A of this profile 14 also has two rigidification strips, 60, 62, formed in the front height 24. These strips, 60, 62 have a concave shape, open towards the outside of the envelope 15A. The cross-section of each of these strips 60, 62 is roughly a 120° arc of a circle. The strips 60, 62 extend all the way along the length of the beam 12.

The first strip 60 is in the upper part of the front height 24, while the second strip 62 is in the lower part of front height 24. This profile is essentially produced in the same way as the profile described above. The difference is that after folding the flanges 50, 52, an extra stage to form the rigidification strips 60, 62 is performed.

The profile shown in FIG. 2C differs from that in FIG. 2B because the first rigidification strip 60 is on the upper part of the side with rear height 26. In addition, the rigidification core 28 has a convex cross-section domed towards the side of upper width 22. The domed shape makes it easier to deform on impact and provides a large capacity for energy absorption.

The profile shown in FIG. 2D consists of straight section segments, like the profile shown in FIG. 2A. It differs from the profile shown in FIG. 2A in that it includes a third segment in section 34, which is folded at an angle of 90°+α to the sixth segment of section 36. The angle a is less than 3.5°.

FIGS. 2E and 2F show two variants of a second method of producing the profile according to the invention. This profile differs from the first method of production in that it has only a single margin constituting the section segments of envelope 15A. The succession of section segments, across the width of the metal sheet, is as follows:

First part of connection 29A, fourth segment of section 36, third segment of section 34, sixth segment of section 40, seventh segment of section 42, first segment of section 30, fifth segment of section 38, second segment of section 32, second part of connection 29B. Between all the section segments 36, 34, 40/42, 30 and 38, the metal sheet is folded in the first direction P1, i.e. anti-clockwise in FIGS. 2E and 2F. The sixth segment of section 40 and the seventh segment of section 42 are connected together in a rectilinear manner. Between the second segment of section 32 and the second part of the connection 29B, the metal sheet is folded in the second direction P2, opposite that of the first direction P1. In this case, direction P2 is clockwise in FIGS. 2E and 2F. Consequently, the second part of connection 29B is fixed to the rear surface formed by the section segments 40, 42 of the side with front height 24, so that it does not have a flange.

This profile 14 also includes rigidification strips 60, 62 on the side with front height 24. The strips 60, 62 are generally U-shaped, open towards the front. The variant of profile 14 shown in FIG. 2F, has a structure generally identical to that of the profile shown in FIG. 2E. The difference is that the rigidification strips 60, 62 have a drop-shaped cross-section. It should be noted that in all the variants of rigidification strips 60, 62, the radius of curvature of the cross-section at all points is three times greater than the thickness e of the metal sheet. Profile 14 according to the invention is light and rigid for the dimensions given. It is also easy to produce. As a variant, connection parts 29A, 29B can be glued to the rest of the profile.

The invention has been described in an illustrative manner. It is to be understood that the terminology, which has been used, is intended to be in the nature of words of description rather than of limitation.

Many modifications and variations of the invention are possible in light of the above teachings. Therefore, within the scope of the appended claims, the invention may be practiced other than as specifically described.

What is claimed:

1. An automobile structural element having a profile (14) extending along a longitudinal direction (L), and including an external envelope defining a closed content in section, characterized in that it includes a transverse rigidification core (15B) inside the envelope and connecting two opposite points of the envelope;
in that said profile is made of a metal sheet blank with two longitudinal edges (44, 46), the metal blank consisting of:
an area (32) forming said rigidification core (15B) of said profile, and
at least one longitudinal margin (40, 34, 36, 29A; 38, 30, 41, 29B) folded longitudinally;
the two longitudinal edges (44, 46) of said metal sheet blank being connected to the said metal blank in its running part.

2. An automobile structural element as set forth in claim 1 characterized in that said envelope has a cross-section in the shape of a quadrilateral and includes two width sides (20, 22) and two height sides (24, 26) with said rigidification core extending between the width sides (20, 22);
in that the cross-section is formed of:
six section segments of said envelope including two section segments (30, 32) and two section segments (36, 38, 40, 42) each forming the two width sides (24, 26), and
two first (29A) and second (29B) connecting parts, and in that it includes a section segment (32) which forms said rigidification core (15B).

3. An automobile structural element as set forth in claim 2, characterized in that said metal blank includes two longitudinal margins (29A, 34, 36, 40; 29B, 30, 38, 42) which are on either side of the said rigidification core (15B) and in that the said margins (29A, 34, 36, 40; 29B, 30, 38, 42) are folded in the first (P1) and second (P2) opposite directions towards the said rigidification core (28).

4. An automobile structural element as set forth in claim 3 characterized in that said cross-section is formed by the following succession of section segments:
first connecting part (29A)
first section segment (36) of a first height side (26)
section segment (34) of a first width side (20)
first section segment (40) of a second height side (24)
section segment (32) of rigidification core (15B)
second section segment (38) of the said first height side (26)
section segment (30) of a second width side (22)
second section segment (42) of the said second height side (24)
second connecting part (29B).

5. An automobile structural element as set forth in claim 4 characterized in that said metal sheet blank is folded by about 90° from one section segment to the next, in the said first direction (P1) between the said first section segment (36) of the said first height side (26) and said section segment (32) of said rigidification core (15B) and in the said second direction (P2) between the section segment (32) of said rigidification core (15B) and the said second segment section (42) of the said second height side (24).

6. An automobile structural element as set forth in claim 5 characterized in that said cross-section is symmetrical with respect to a central axis (X-X) extending in a longitudinal direction.

7. An automobile structural element as set forth in claim 1 characterized in that the blank has a single longitudinal margin (29A, 30, 34, 36, 38, 42) folded in one direction (P1) around the rigidification core (28).

8. An automobile structural element as set forth in claim 7 characterized in that said cross-section of said profile is formed by the following succession of section segments:
first connecting part (29A)
first section segment (36) of a first height side (26)
section segment (34) of a first width side (20)
first (40) and second (42) section segments of a second height side (24)
section segment (30) of a second width side (22)
second section segment (38) of the said first height side (26)
section segment (32) of rigidification core (15B)
second connecting part (29B).

9. An automobile structural element as set forth in claim 8 characterized in that said sheet is folded roughly 90° between one section segment and the next in the said first direction of folding (P1), except for the connection between the said first (40) and second (42) section segments of the said second height side (24), these two section segments being roughly parallel to each other.

10. An automobile structural element as set forth in claim 9 characterized in that said metal sheet is folded roughly 90° between said section segment (32) of said rigidification core (15B) and the said second connecting part (29B) in a second direction of folding (P2) opposite the said first direction of folding (P1).

11. An automobile structural element as set forth in claim 10 characterized in that it includes at least one rigidification (10) strip (60, 62) extends along the length of said profile (14), and forming a hollow opening towards the outside of said profile.

12. An automobile structural element as set forth in claim 2 characterized in that said two section segments (30, 34) of the side of width (20, 22) and said section segment (32) of said rigidification core (15B) are domed.

13. An automobile structural element as set forth in claim 11 characterized in that the thickness (e) of said metal sheet blank is roughly identical throughout the cross-section.

14. Chassis of an automobile with two members (4) and a bumper (12), characterized in that said bumper (12) includes a profile (14) as in any of the previous claims.
